(19) United States
(12) Patent Application Publication
(10) Pub. No.: US 2024/0075653 A1
(43) Pub. Date: Mar. 7, 2024

(54) TILE SAW

(71) Applicant: Black & Decker, Inc., New Britain, CT (US)

(72) Inventors: Peter Chaikowsky, Forest Hill, MD (US); Robinson Lu, Towson, MD (US); Chunlin Wu, Towson, MD (US); Eric Tang, Towson, MD (US); Marcus Rompel, Runkel (DE)

(21) Appl. No.: 18/388,408

(22) Filed: Nov. 9, 2023

Related U.S. Application Data
(63) Continuation of application No. PCT/US2022/025890, filed on Apr. 22, 2022.
(60) Provisional application No. 63/178,355, filed on Apr. 22, 2021.

(51) Int. Cl. B28D 1/04

(52) U.S. Cl. CPC B28D 1/047

(57) ABSTRACT

A saw assembly including a base, a frame assembly disposed on the base and a rail system disposed on the frame assembly. The rail system extends in a longitudinal direction and a table assembly is slidingly disposed in the longitudinal direction on the rail system. The assembly includes a split table having a first table portion and a second table portion separated by a gap extending parallel to the longitudinal direction of the rail system. A pair of fences are mounted to the first and second table portions and bridge the gap to connect the first and second table portions to each other. The gap and corresponding channels and drain apertures allow the tile saw to channel and retain water while cutting a tile. At least one of the fences has a projection in the form of a bridge that is pivotable about the fence to move the projection away from the path of the blade.

### CROSS-REFERENCE TO RELATED APPLICATIONS

The present application claims priority to U.S. Provisional Patent Application Ser. No. 63/178,355 entitled “Tile Saw”, filed Apr. 22, 2021 and is a continuation of international application PCT/US2022/025890, filed on Apr. 22, 2022. The entirety of the above applications are incorporated herein by reference.

### FIELD OF THE INVENTION

This invention relates generally to tile or masonry saws and, more particularly, to tile saws with expanded capacity.

### BACKGROUND OF THE INVENTION

### Description of the Related Art

A typical tile saw includes a base which supports a generally flat tabletop. A saw unit may be disposed on the base or table for cutting a workpiece, such as a tile or masonry brick, disposed on the table. However, the maximum cutting capacity of such tile saws is limited by the size of the machine or “envelope”.

Accordingly, persons skilled in the art have devised a tile saw where the base has two tracks and the table has bearings or wheels riding on the tracks, so that the table can be moved relative to the saw unit for increased capacity. Such tile saws, however, are usually susceptible to dust collecting between the tracks and wheels, which creates binding between the base and the table. Ultimately, the binding may cause uneven, inaccurate cuts, which may translate into loss of time, materials and/or profit for the user.

Further, the capacity of such tile saws is usually limited to the length of the tracks. In other words, if a user wants increased capacity, the user may have to lengthen the tracks. However, longer tracks may result in less portability of the tile saw. Additionally, reducing the size of the saw to improve portability often results in a decreased capacity.

It is therefore an object of this invention to provide a saw in a compact size with increased cutting capacity without sacrificing portability. The movable table and rail system surround the blade. As such, the table assembly and rail system are on both sides of the blade to support the workpiece and improve cutting quality.

### SUMMARY OF THE INVENTION

In accordance with the present invention, an improved tile saw is employed. The saw comprises a base, a frame assembly disposed on the base, a rail system disposed on the frame assembly, the rail system extending in a longitudinal direction, a table assembly movably disposed on the rail system, a power source, a support assembly disposed on the one of the base and the frame assembly, a saw assembly supported by the support assembly. The saw assembly includes a motor driven by the power source and a blade driven by the motor. The rail system can be on one side or both sides of the blade. A table assembly is slidingly disposed on the rail system. The table assembly includes a table body having a first table portion and an adjacent second table portion separated by a gap extending parallel to the longitudinal direction of the rail system.

In an embodiment, at least one fence member connects the first table portion and the second table portion. In an embodiment, the at least one fence member has a blade channel to accommodate an edge of the blade.

In an embodiment, the at least one fence member can include a first fence member connecting the first table portion and the second table portion at one end of the table body and a second fence member connecting the first table portion and the second table portion at a second end of the table body opposite the first end.

In an embodiment, a one piece table body can include a gap therethrough, the gap being parallel to the longitudinal direction of the rail system.

In an embodiment the table body includes a recess in an upper surface thereof and a bevel plate is supported in the recess.

In an embodiment the bevel plate is pivotable to a plurality of angles with respect to the upper surface of the table body.

The present invention also provides a tile saw that is able to channel and retain water while cutting a workpiece such as tile, stone, brick, or glass.

### BRIEF DESCRIPTION OF THE DRAWINGS

The accompanying drawings illustrate preferred embodiments of the invention according to the practical application of the principles thereof, and in which:

FIG. 1 illustrates a top and front perspective view of a tile saw according to the present invention;

FIG. 2 illustrates a front and side perspective view of the tile saw of FIG. 1 according to the present invention;

FIG. 3 illustrates a rear and side perspective view of the tile saw of FIG. 1 according to the present invention;

FIG. 4 illustrates a top perspective view of the table of the tile saw of FIG. 1 according to the present invention;

FIG. 5 illustrates a bottom perspective view of the table of the tile saw of FIG. 1 according to the present invention;

FIGS. 6A and 6B illustrate partial front left and front right side views of the tile saw of FIG. 1 according to the present invention;

FIGS. 7A and 7B illustrate side views of the table in front and rear cantilevering positions of the tile saw of FIG. 1 according to the present invention;

FIG. 8 illustrates a top perspective view of the frame assembly and base of the tile saw of FIG. 1 showing the basin according to the present invention;

FIG. 9 illustrates a top view of the transmission and motor without the frame of the tile saw of FIG. 1 according to the present invention;

FIG. 10 illustrates a bottom view of the tile saw of FIG. 1 according to the present invention;

FIG. 11 illustrates the blade guard of the tile saw of FIG. 1 according to the present invention;

FIG. 12 illustrates a front and side perspective view of a second embodiment of present invention;

FIG. 13 illustrates a front and side perspective view of the tile saw of FIG. 12 according to the present invention;

FIG. 14 illustrates a front view of the tile saw of FIG. 12 according to the present invention;

FIG. 15 illustrates a rear and side perspective view of the tile saw of FIG. 12 according to the present invention;

FIG. 16 illustrates a bottom perspective view of the table of the tile saw of FIG. 12 according to the present invention;

FIG. 17 illustrates a top and front perspective view of the frame assembly and base showing the basin of the tile saw of FIG. 12 according to the present invention;

FIG. 18 illustrates a top view of the transmission and motor without the frame of the tile saw of FIG. 12 according to the present invention;

FIGS. 19A and 21B illustrate a top views of a table and fence of the tile saw of FIG. 12 according to the present invention;

FIGS. 20A and 20B illustrate top views of an alternate table and fence of the tile saw of FIG. 12 according to the present invention;

FIGS. 21A and 21B illustrate a side views of the alternate table and fence of FIGS. 20A and 20B;

FIG. 22 illustrates a top view of the tile saw of FIG. 12 and workpiece with the fence extended parallel to the table surface;

FIG. 23 illustrates a side view of the tile saw of FIG. 12 and workpiece with the fence extended parallel to the table surface; and

FIGS. 24A and 24B illustrate a top and side perspective view of a third embodiment of the tile saw having an adjustable bevel plate section.

### DETAILED DESCRIPTION OF THE INVENTION

The invention is now described with reference to the accompanying figures, wherein like numerals designate like parts.

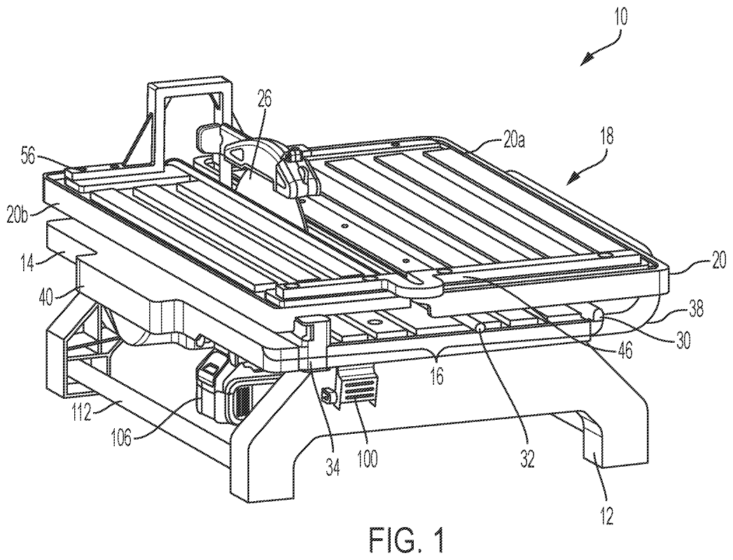

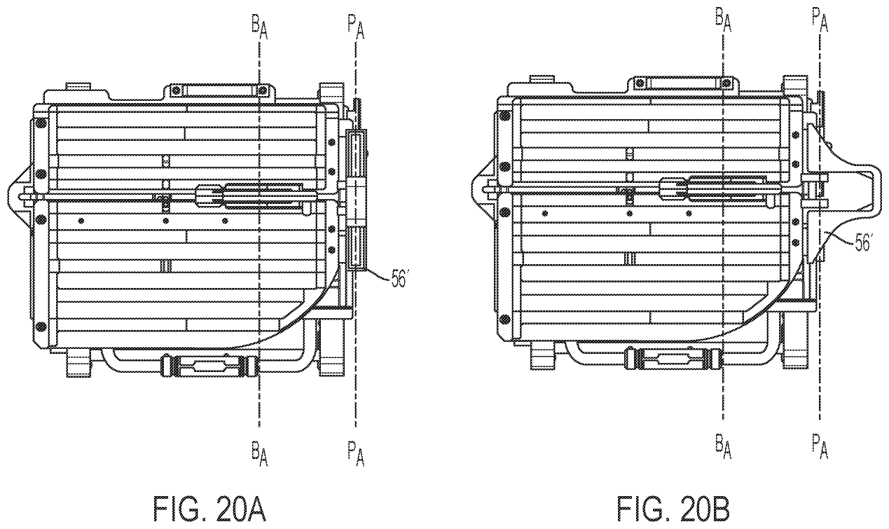

FIGS. 1-3 illustrate an exemplary embodiment of a sliding table tile saw 10 of the present invention. The sliding table tile saw, hereinafter tile saw 10, has a stand or a base 12 so that the tile saw may be placed on a table or other flat surface. A frame assembly 14 may be disposed on base 12. Frame assembly 14 may support rail system 16 and table assembly 18. Rail system 16 defines a longitudinal direction of the tile saw 10. Table assembly 18 is movable along rail system 16. Table assembly 18 includes a movable table 20 having a table body. Frame assembly 14 may also support a saw assembly 22 that supports several actuating members of the tile saw 10. The saw assembly 22 is disposed on the frame assembly 14. The saw assembly 22 includes a motor assembly that includes a transmission member 24 and a motor 28. The transmission member 24 may support a cutting wheel such as a blade 26 for cutting a workpiece W. The workpiece W can be tile and/or stone, including, but not limited to, ceramic tile, porcelain tile, stone, brick, or glass. The workpiece W can be disposed on table assembly 18 and moved into contact with the blade 26. The transmission member 24 and motor assembly 28, can be disposed under the table assembly 18 and supported by the frame assembly 14. The blade 26 is rotatable by the motor assembly 28 about an axis BA (FIG. 20A, 20B) and is disposed within the frame assembly 14.

The base 12 can be constructed with a height to provide a clearance between the frame assembly 14 and the table body or flat surface and to accommodate operative elements, such as the motor assembly 28 and the blade 26 of the tile saw 10. The base 12 can also be sectioned longitudinally into front and rear segments. One or more strengthening bars 112 can be provided to support and connect sections of the base. Base 12 is preferably injection molded or vacuum formed for supporting the different elements of the tile saw 10 as described below. Base 12 may be made of polypropylene with calcium carbonate filler, such as Astryn 75A6-2 by Basell, HDPE (High Density Polyethylene) or ABS.

The rail system 16 includes a plurality of rails arranged in parallel and which define a longitudinal direction of the tile saw 10. Table assembly 18 is movable on the rail system 16 along the longitudinal direction of the tile saw 10. The rail system 16 includes a first rail 30, a second rail 32, and a third rail 34. The first rail 30 is a support rail that can be integrally formed with the frame, such as by casting. The first rail 30 can prevent tilting of the table assembly 18. The second rail 32 serves as a guide rail that keeps the table assembly 18 parallel to the blade 26. The second rail 32 can be in the form of a cylindrical rod, for example. In an embodiment, the second rail 32 can be formed from stainless steel. The third rail 34 can have a substantially C-shaped cross-section throughout a major portion, if not all, of its entire length, and supports the table assembly 18 when the table assembly cantilevers. In an embodiment, the third rail 34 can be integrally formed with the frame assembly 14. As shown in FIG. 1, the second rail 32 is disposed between the first rail 30 and the third rail 34. In an embodiment, the rails 30, 32 and 34 have different cross sections. Two or more rails can have the same or substantially similar cross-sections. Alternatively, all the rails can have substantially similar or the same cross-sections.

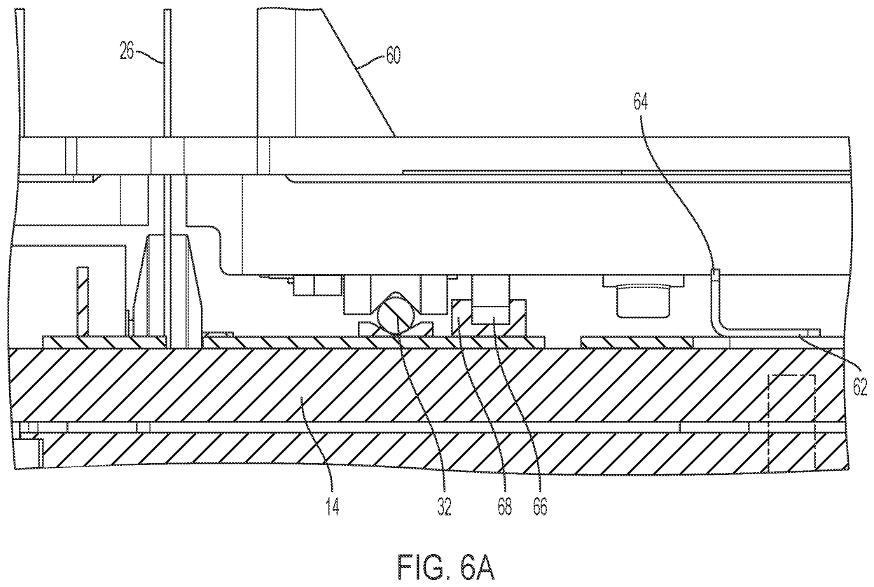

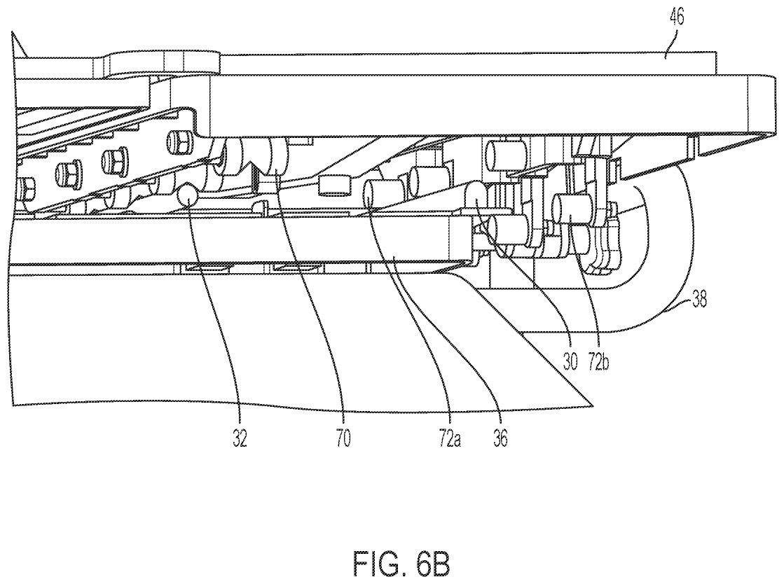

The frame assembly 14 has a frame body 36 (FIG. 6A). The frame body 36 can be cast from aluminum. The frame assembly 14 also includes an attachable carry handle 38 on a side of the tile saw near the first rail 30, to improve portability. The attachable carry handle 38 can project outwardly and curve upwardly with respect to the frame assembly 14 for the purpose of the user being able to grasp the handle for carrying the saw 10. The frame assembly 14 also includes an integrated lifting handle 40 on the opposite side of the tile saw near the third rail 34. The integrated lifting handle 40 includes a recess on the underside thereof to allow the user's hand to grip the frame body 36.

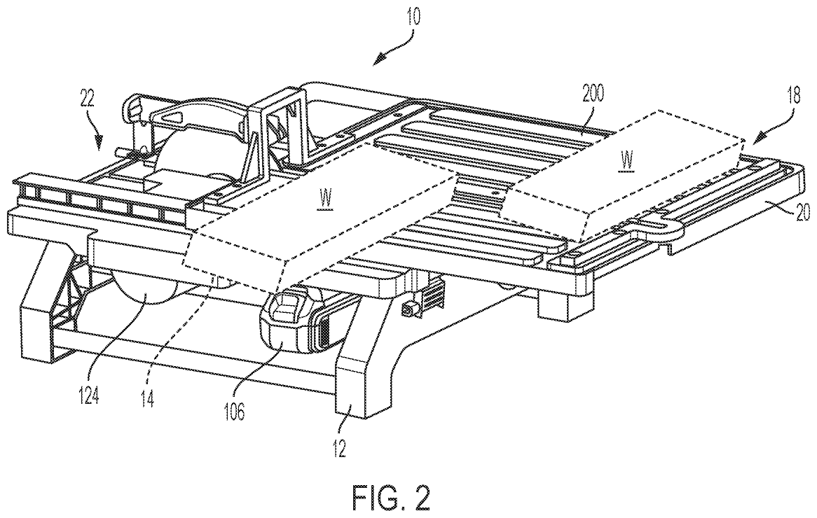

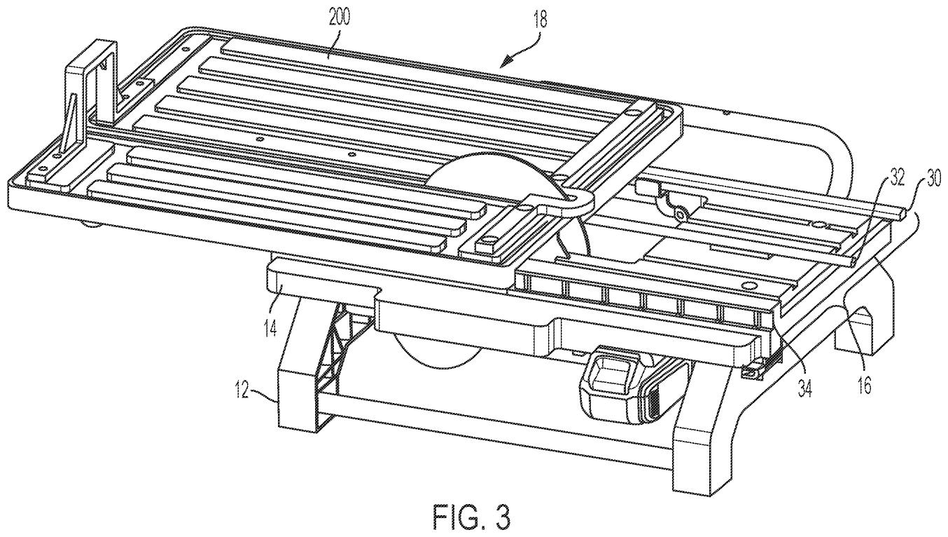

The table assembly 18 is slidable to multiple positions as shown in FIGS. 2 and 3 along the rail system 16. As shown, the blade 26 of the saw assembly 22 extends up from below the table assembly 18 so that a portion of the blade is exposed through the movable table 20.

FIGS. 2 and 3 illustrate an operation of the tile saw 10. As shown in FIG. 2, workpiece W is placed on the table surface 200 with the sliding table assembly 18 slid toward a front of the tile saw 10, which is away from the blade 26. As shown in FIG. 2, although the workpiece W is supported by the table support surface 200, it may be advantageous to include a holder to secure the workpiece W in place on the table assembly 18. The holder may be, for example, a screw clamp.

Once the workpiece W is placed on the table assembly 18, as shown in FIG. 2, the table assembly 18 is slidable towards the blade 26 as shown in FIG. 3 so that the saw assembly 22 begins to cut the workpiece W. As shown in FIG. 3, the table assembly 18 slides to the end of the table to completely cut the workpiece W.

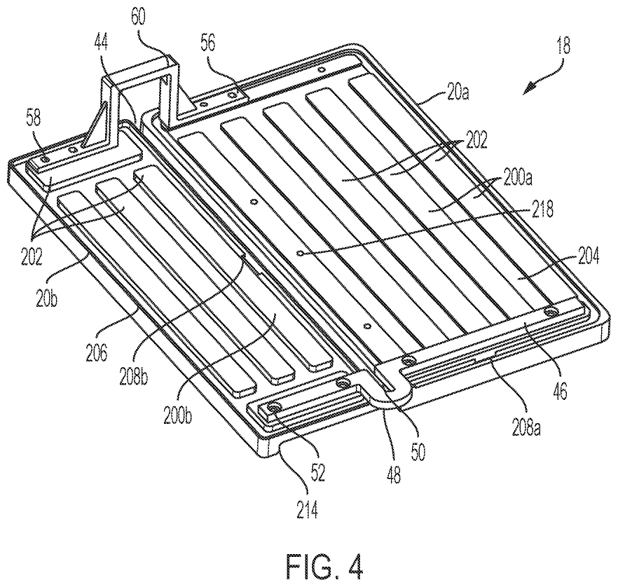

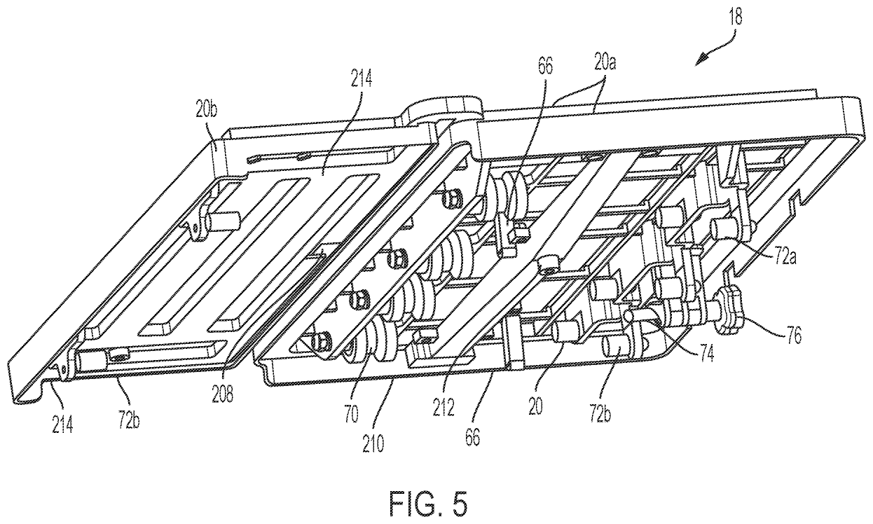

The table 20 is described in more detail with respect to FIGS. 4 and 5. FIG. 4 illustrates the support surface 200 of the movable table 20 and FIG. 5 illustrates the underside 300 of the table.

The table 20 has a first table portion 20a and a second table portion 20b. In an embodiment, the first table portion 20a and the second table portion 20b are separate sections of the table assembly 18 that are arranged next to each other to form the table 20. The first table portion 20a and the second table portion 20b have adjacent longitudinal sides that define the longitudinal length or ends of the table 20. The longitudinal sides of the first and second table portions are disposed adjacent to each other and define a gap 44 therebetween. The gap 44 extends in the longitudinal direction, parallel to the rail system 16. The gap 44 has a width G that accommodates the cutting edge of the blade 26. In an embodiment, the gap 44 has a width G that is based on the thickness of the blade. In an embodiment, the gap 44 is larger than the thickness of the blade 26. In an embodiment, the gap 44 is less than 5%, 4%, 3% 2% or 1% larger than the thickness of the blade 26.

As shown in FIG. 4, each table portion 20a and 20b includes a support surface on which a workpiece W or other item to be cut may be placed. As such, the support surface 200 is split into two surfaces. The first table portion 20a has a first support surface 200a and the second table portion 20b has a second support surface 200b. The first support surface 200a and the second support surface 200b lie in the same plane. The rotational axis BA of the blade 26 is between the support surfaces plane and the base 12.

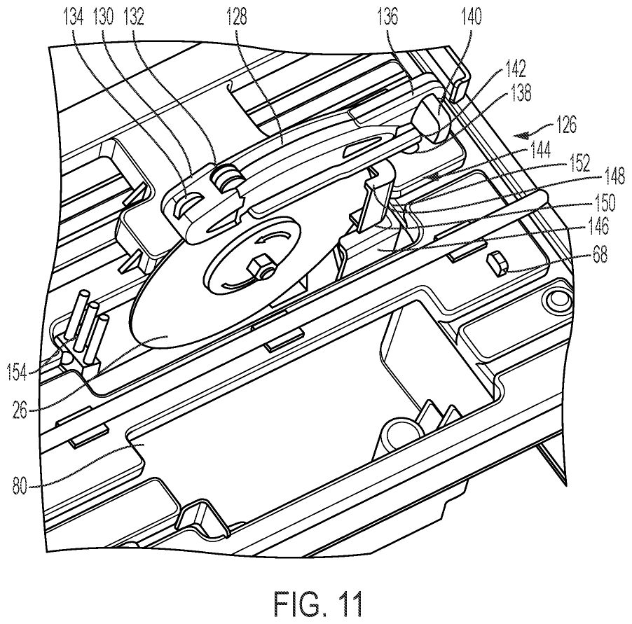

The support surfaces 200, 200a, 200b include and are defined by raised portions 202 which can be generally rectangularly shaped, and channels 204 which separate the raised portions. The channels 204 slope toward the center of the table 20 and channel fluids, such as water from the table surface 200 to apertures 208a, 208b. Beneath the center of the table 20 and disposed on the underside 300, is a basin 80 (FIG. 11) mounted to the underside of the base 12. The basin 80 collects the water that flows from the channels 204.

The table also includes a raised lip 206 around the perimeter. The raised lip 206 keeps the water within the perimeter of the table surface 200. Further water control is provided by at least one drain aperture in the table surface 200. Drain apertures 208a and 208b are disposed through the table 20 from the support surface 200 to the underside 300. Drain aperture 208a can be disposed through a channel 204 along the perimeter of the first table portion 20. Drain aperture 208b can be disposed through one of the channels 204 in the second table portion 20b. The channel 204 in which the drain aperture 208b is located, can have a surface that is angled toward the drain aperture, to promote the flow of water toward the basin 80. Each table portion 20a, 20b can have one or more than one drain aperture. The drain apertures 208a, 208b are disposed over or above the basin 80 in the frame assembly 14.

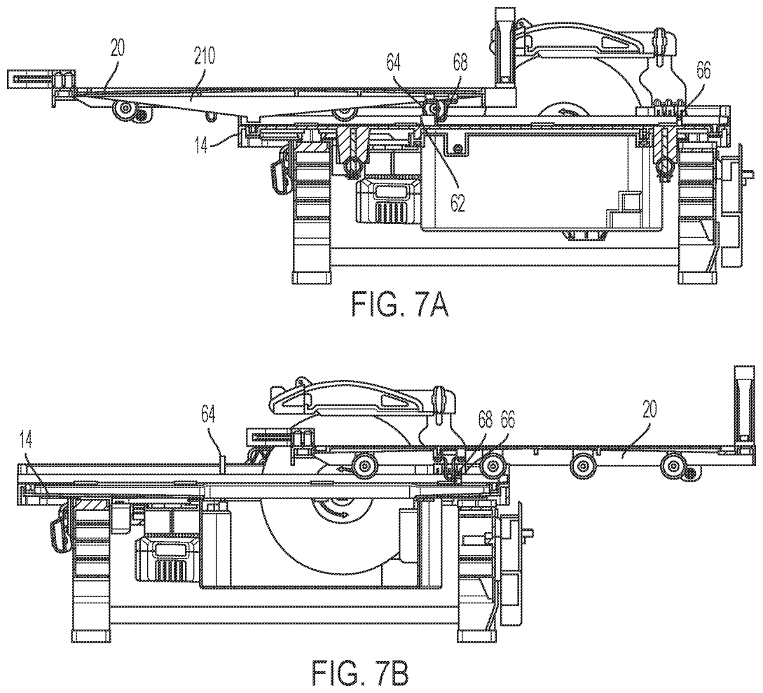

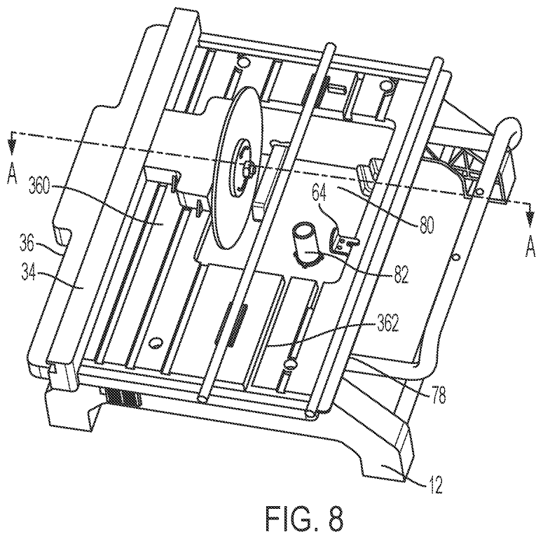

Once in the perimeter of the table 20, the water drains from the side edge portion and the front/rear edge portions into the drainage section 210 beneath the table 20. The drainage section 210 includes a drainage hole 212 through which the water falls back into basin 80, where it can be again used to cool the tile saw blade 26. The drainage hole 212 is generally centrally located under the table 20 so that it will always drain into the basin 80. The drainage hole 212 remains within the perimeter or footprint of the table 20 even during cantilevering of the table, as shown in FIGS. 7A and 7B. The basin 80 can be filled with water so that the blade 26 is cooled as the blade rotates through the water. Each of the first table portion 20a and the second table portion 20b may be designed such that the drain aperture 208a or 208b is placed at the lowest elevation to promote water flow to the drain aperture from other parts of the table surface 200.

In an embodiment, one table portion can be larger than the other table portion. As shown in FIGS. 1 and 4, first table portion 20a can be larger than second table portion 20b. In an embodiment, the ratio of the size of one table portion to the other table portion can be 2:3. Alternatively, for example, the ratio of the size of one table portion to the other table portion can be 1:4 or 2:5 or 3:5 or 4:5. Alternatively, the table portions 20a, 20b can be of equal size. In an embodiment, at least one of the table portions has a recess 214 at the bottom edge for the purpose of providing clearance over a portion of the rail assembly 16.

The table assembly 18 also includes a plurality of fences 46, 56 that hold the first table portion 20a and the second table portion 20b together. A fence provides a surface against which a workpiece can be rested. A fence allows the user to accurately align the workpiece W with the blade 26. The workpiece W may be placed against a length of the fence so that the workpiece can be cut into two pieces.

In an embodiment, a first fence member 46 defines a longitudinal end of the table 20 and the second fence member 56 defines the opposite longitudinal end of the table. As shown in FIG. 2, a workpiece W can be placed against the first fence member 46 and/or the second fence member 56 to be cut.

The first fence member 46 includes a projection 48 that projects outwardly of the tile saw 10 in a direction parallel to the support surfaces 200a, 200b. The projection includes a cutout that serves as a blade channel 50. The blade channel 50 is aligned with the gap 44 between the first table portion 20a and the second table portion 20b. The blade channel 50 accommodates the blade 26 of the saw assembly 22. As shown in FIG. 3, the blade 26 will extend into the blade channel 50 when the table assembly 18 is completely pushed in one direction. The blade channel 50 allows for the workpiece W to be completely cut through. The workpiece W can be placed on the support surface 200 of the table 20 and be cut by the blade 26 when the blade is rotated by the motor 28 and the table assembly 18 is slid on the rail system 16. The first fence member 46 can be attached to the support surface 200 of the table 20 by fasteners, such as screws (not shown) through apertures 52 in the first fence member. The apertures 52 in the first fence member 46 allow the fence member to be adjustable.

The second fence member 56 can also be attached to the support surface 200 of the table 20 by fasteners, such as screws (not shown) through apertures 58 in the second fence member. The second fence member 56 includes a projection in the form of bridge portion 60 that projects outwardly and above the support surface 200 of the table 20. The bridge portion 60 of the second fence member 56 is disposed over the gap 44 which allows the blade 26 and an associated blade guard 126 to pass therethrough.

Alternatively, the table, first fence member and second fence member can be cast as a single part, eliminating the need for apertures and screws.

As shown in FIGS. 3, 6A and 6B, the frame assembly 14 includes a plurality of stop members 62, 68. The stop members engage catch members under the table 20 to limit the distance of travel of the table assembly 18 on the frame body 36. In an embodiment, a first stop member 62 is provided. The first stop member 62 can be a rotatable member having an extension 64 that engages one of a plurality of table catch members 66. In a first position, the stop member 62 engages one of the table catch members 66 depending from the underside of the table body 20 to limit the distance of travel of the table assembly 18 along the longitudinal length of the frame assembly 14 and prevent the table assembly from being lifted off of the frame body 36. In a first position, the stop member 62 also stops the blade 26 from contacting the first fence member. In a second position the stop member 62 is rotated to a bypass position to locate the extension 64 out of the path of the catch member 66, allowing the table assembly to bypass the stop member 62 and be removed from the table frame. FIGS. 3 and 6A illustrate the stop member 62 in the bypass position. The table catch member 66 can be a rigid member affixed to the underside of the table 20 such that engagement with the extension 64 prevents the table from moving further. In another embodiment, the stop member can be a push button member that when activated by pressing inward, allows the table assembly to bypass the stop member and be removed from the frame assembly.

In an embodiment, shown in FIG. 6A, a second stop member 68 is provided. The second stop member 68 can be a fixed member projecting upward from a surface of the frame body 36. In an embodiment, the second stop member 68 can be integrally cast with the frame body 36. The second stop member engages with another of the table catch members 66.

As shown in FIGS. 5, 6A, 6B, 7A and 7B, the underside 300 of the table 20 includes at least one transmitting body that allows the table assembly 18 to move from a first position to a second position.

In an embodiment, the transmitting body can include guide rollers 70 and support rollers 72a and 72b. The guide rollers 70 and support rollers 72a and 72b are mounted to ribs on the underside 300 of the table 20 and engage the rails 30, 32, 34 of the rail system 16. In particular, as shown in FIG. 6B, the guide rollers 70 are disposed on top of the second rail 32 and guide the table assembly 18 in a linear manner on the rail 32. The guide rollers 70 have a recessed or V-shaped groove sandwiched between a pair of sidewalls. The guide rollers 70 rotate about a guide roller axis and are able to guide the table assembly 18 along its recessed groove between the sidewalls, which serve as lateral boundaries for table along the second rail 32.

The support rollers include upper support rollers 72a that support the table assembly 18 on top of the first rail 30 and third rail 34, and lower support rollers 72b that ride on the underside of the first rail 30. The lower support rollers 72b keep the table assembly 18 level when cantilevered at the front or rear of the saw assembly 22. The guide rollers 70 provide support for the table assembly 18 to roll along the rail system 16.

The table assembly 18 is moveable by rolling such as by the guide rollers on the second rail 32 and/or by sliding, such as by the upper and lower support rollers 72a, 72b. The support rollers serve as a stop to prevent the table assembly 18 from being lifted up off of the frame body 36.

The table assembly 18 also includes roller locating members 218 that are used to align the guide rollers 70 to each other. In an embodiment, the roller locating members 218 align the middle guide rollers 70 to the first and last guide rollers 70. The roller locating members 218 include set screws 220 that serve as adjustment and locking members for the guide rollers 70.

In other embodiments, the transmitting body can include sliding members or gears, blades, or rods. Also, in other embodiments, the rail system can be disposed on the table assembly and the transmitting body can be on the frame. For example, the guide rollers 70 and support rollers 72a, 72b can be fixed to the frame.

In the present embodiment, the table assembly 18 can be removed from the tile frame assembly 14 by sliding the table assembly completely off the rails 30, 32, 34 forward or backward or from the front end or rear end of the saw assembly 22. In other embodiments, there may be a stop at either or both ends or the center of the frame body 36 in order to prevent the table assembly 18 from sliding off. Additionally, the table assembly 18 may be locked in place so that it does not slide. This may be particularly helpful during transport of the tile saw 10. A table locking bar 74 locks the table assembly 18 in position on the frame assembly 14 as shown in FIG. 5. The table locking bar 74 has an elongated body at one end and a gripping knob 76 at the opposite end. The gripping knob 76 can be held by the user to move the locking bar axially through an aperture in the frame body. In an embodiment, the locking bar 74 can be spring-biased away from the gripping knob 76 such that when the aperture in the frame body 36 is aligned with the locking bar, the locking bar would be biased into the aperture.

FIG. 8 is an illustration with a portion of the table surface 200 removed to show the top of the frame body 36, the blade 26 and basin 80, as mounted to the frame assembly 14. The frame body 36 can be mounted to the base 12 by a plurality of screws (not shown) through the frame body 36. As shown in FIG. 8, frame body 36 includes a frame surface 360 on which the rail assembly 16 is disposed. The frame surface 360 includes a plurality of frame channels 362 that are angled with respect to the frame surface. The frame channels 362 guide water that lands on the surface of the frame surface 360 into the basin 80. The frame channels 362 can be arranged in parallel, as shown, or in any configuration that allows water to flow into the basin 80. The blade 26 is rotationally attached to the frame such that one portion of the blade is disposed within or extends into the basin 80. The basin 80 may be filled with water. As will be appreciated, as the blade 26 rotates, it will pass through the water in the basin 80, which will serve to clean and cool down the blade 26. The basin includes an overflow tube 82 that prevents a high level of water from entering the motor and transmission housing 124.

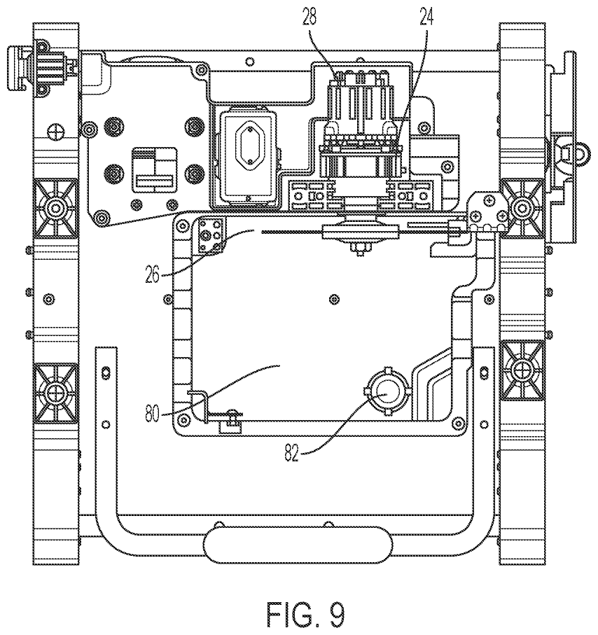

FIG. 9 illustrates a top view of the tile saw 10 with the table and frame removed to show the blade 26, basin 80, transmission member 24 and motor 28.

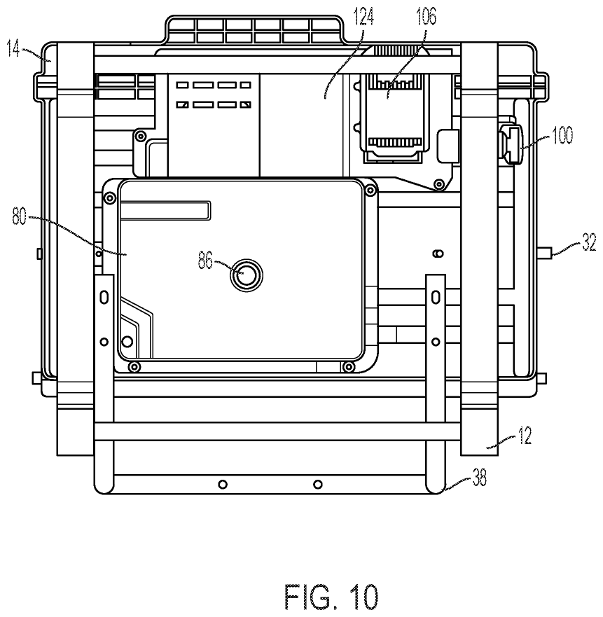

FIG. 10 illustrates the underside of the frame assembly 14. Operating components of the saw assembly 22 including the motor 28 and the transmission 24 are located on or mounted to the underside of the frame assembly 14. The transmission 24 and the motor 28 are housed in a motor and transmission housing 124, as is known in the art.

As shown in FIG. 10, the basin 80 has a basin drain 86. The basin drain 86 limits the amount of water that can be put into the basin 80. Additionally, the basin drain 86 allows a user to pour out water from the basin 80, such as before storage. The basin drain 86 can be plugged. The plug (not shown) may be inserted to keep water in the basin 80 or removed to allow water to be drained from the basin 80.

The saw assembly 22 can be turned on or off by a user. The embodiments of FIGS. 1 and 10 illustrate an ON/OFF switch 100. The switch 100 is mounted in the base 12 of the saw and can be actuated by engagement with a lever 102 that is mounted on a surface of the base. In an embodiment, the user can turn the saw assembly 22 ON and OFF by pressing the lever 102 against an actuator portion 104 of the switch 100. In an embodiment, the user can turn the saw assembly 22 ON by pivoting the lever 102 against the actuator portion. In this instance, a non-momentary switch may be used in which the saw stays in the ON position until the user manually disengages the lever 102 from the actuator portion 104 of the switch 100. In an alternative embodiment, the ON/OFF switch 100 can be a pedal such as a foot pedal. The pedal can be momentary, meaning that the saw assembly 22 will only stay ON as long as the pedal is depressed. The saw assembly 22 of the exemplary embodiment is powered by a power tool battery pack 106 as shown in FIGS. 1-3. The saw assembly 22 may also be powered through a power cord.

FIG. 11 illustrates the blade 26 and blade guard 126. The blade guard 126 is disposed over a cutting edge of the saw blade 26. The blade guard 126 includes a fixed portion 128 and a movable portion 130 that can move with respect to the fixed portion 128. In this case, the movable portion 130 rotates with respect to the fixed portion 128. The movable portion 130 is connected to the fixed portion 128 via a connector 132. In the exemplary embodiment, the connector 132 is a pin. Other connectors may also be used. The movable portion 130 also includes a ridge 134. The ridge 134 is configured for a user to engage and move the movable portion 130 to an open position.

The blade guard 126 is attached to the tool through a support assembly including a mounting bracket 136 connected to a mounting support 138. The mounting support 138 is fixed, for example, to the frame body 36, for example by fasteners. The mounting support 138 can be fixed to other surfaces or in other manners or could be integrally formed with other parts of the tile saw 10. The mounting bracket 136 has at least one fastener, such as a thumb screw 140 that can be tightened or loosened to secure the mounting bracket 136 at a particular height with respect to the mounting support 138. The mounting support has a slot 142 that is open at one end to accommodate the thumb screw 140. As will be appreciated, a user can loosen the thumb screw 140 in a tool free manner and then move the mounting bracket 136 up or down to a desired location on the mounting support 138. The user can then retighten the thumb screw 140 to secure the mounting bracket 136 in place. For example, the user may want to raise the mounting bracket 136 to allow for replacement of the blade 26 and have it at a lower position for use of the blade guard 126. In an embodiment, the slot 142 is a U-shaped slot that allows the thumb screw 140 to slide out of the slot to remove the blade guard 126 to allow for replacement of the blade 26.

FIG. 11 also illustrates a water guard 144 in the tile saw 10. The water guard 144 blocks water from spraying off of the blade 26 to the work area. The water guard 144 includes a base portion 146 and a guard portion 148 which is secured to the base portion. The guard portion 148 extends from the base portion 146 close to the blade 26 to cover the blade 26 where it is most prone to spray water. As shown in FIG. 11, the guard portion 148 has a side portion 150 which extends along a side of the blade 26 to block water spraying from the side of the blade 26. The guard portion 148 also has an end portion 152 which extends along a cutting face of the blade 26 so as to block water which may spray from the cutting face. The guard portion 148 also includes an attachment portion (not shown) through which the guard portion may be secured to the base portion 146 such as, for example, by a screw. Alternatively, the guard portion 148 can be internally formed with the base portion 146. The base portion 146 may be integrally formed with the base 12 or may be formed separately and secured to the base.

The water guard 144 is disposed on one radial side of the blade 26. On an opposite radial side of the blade is a brush 154. The brush 154 helps limit the flow of fluid and/or slurry beyond the brush and/or the basin 80. Preferably, the brush 154 has bristles made of nylon or a synthetic rubber-like material.

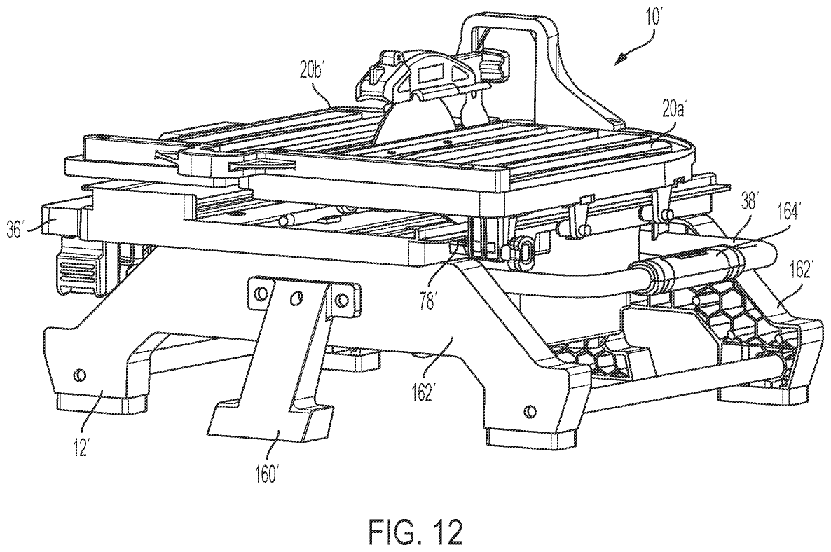

FIGS. 12-18 illustrate another embodiment of the tile saw. The tile saw 10′ in FIGS. 12-18 have similar components to the tile saw 10 of FIGS. 1-11.

The tile saw 10′ has a base 12′ that includes at least one leg member 160′ that provides additional stability for the tile saw. The additional stability may be necessary when a workpiece larger in length or width than the table 20′ is being cut. In an embodiment, the leg member 160′ is attached to the base 12′ at the center of each front 162′ and rear 162′ base segments as shown in FIGS. 12-15. The leg member 160′ can be attached to the base segments by fasteners, such as screws that allow the base to be adjusted as necessary. Alternatively, the leg member 160′ can be constructed and arranged to pivot, rotate, swivel or telescope outward and lock to a position between the base and the tabletop of flat surface upon which the tile saw 10′ is located.

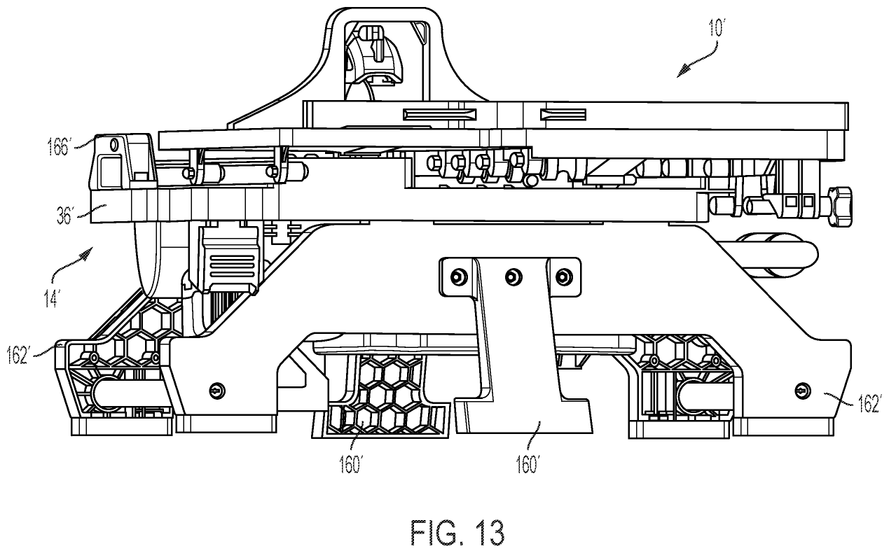

As shown in FIGS. 12, 14, and 17, for example, a carry handle 38′ includes a carry handle gripping member 164′. The carry handle gripping member can be a plastic material and/or made from vinyl. As shown in FIGS. 13, 14, 15 and 17, the frame assembly 14′ includes a support handle 166′. The support handle 166′ can be used for carrying the tile saw 10′. Additionally, the support handle 166′ allows the tile saw 10′ to be stored or set down on its side, such that the rotational axis BA of the blade 26 is perpendicular with respect to a horizontal surface. The support handle 166′ can be a separate member that is attached to the frame body 36′. Alternatively, the support handle 166′ can be integrally cast with the frame body 36′.

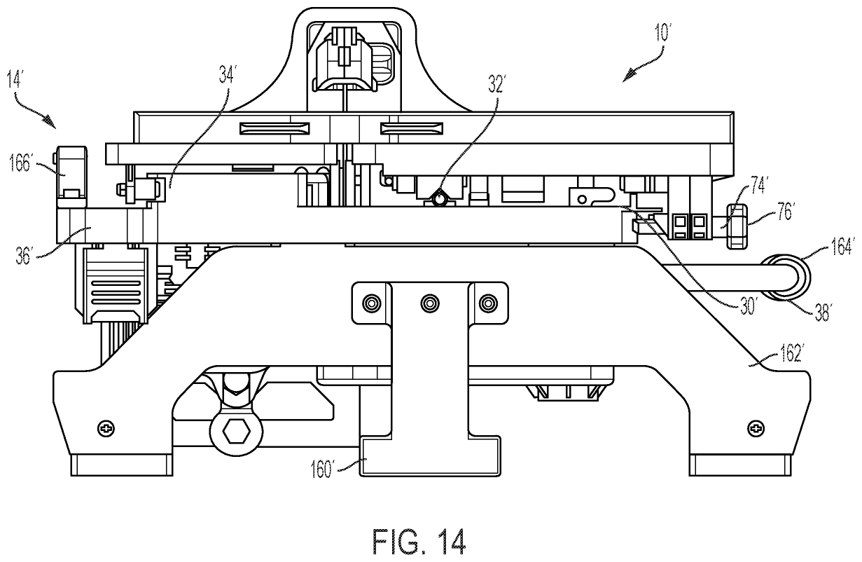

In the present embodiment, the rail system 16′ includes a first rail 30′, a second rail 32′, and a third rail 34′ as shown in FIG. 14. The first rail 30′ is a support rail that can be integrally formed with the frame, such as by casting, and can prevent tilting of the table assembly 18′. The second rail 32′ serves as a guide rail that keeps the table assembly 18′ parallel to the blade 26. The second rail 32′ can be in the form of a cylindrical rod, for example. In an embodiment, the second rail 32′ can be formed from stainless steel. The third rail 34′ can have a substantially C-shaped cross-section throughout a major portion, if not all, of its entire length and supports the table assembly 18′ when the table assembly cantilevers.

In an embodiment, the third rail 34′ can be integrally formed with the frame assembly 14′. As shown in FIG. 14, the second rail 32′ is disposed between the first rail 30′ and the third rail 34′.

FIG. 12 illustrates the table 20′ having a first table portion 20a′ and a second table portion 20b′. As shown in FIGS. 12, 15 and 16, the table 20′ of the table assembly 18′ is non-rectangular, having a curved corner or radial edge 216′ on the first table portion 20a′. The curved section provides additional and/or clearance away from adjacent surfaces and reduces the weight of the table over a fully rectangular table of the same size. The radial edge 216′ can alternatively be on the second table portion 20b′.

The surfaces between the raised first and second support surfaces 200a′, 200b′ are channels 204′. The channels 204′ are non-parallel with the first and second support surfaces 200a′, 200b′. Specifically, the channels 204′ tapered toward apertures in the table 20′ and form a channel system that directs the flow of water by gravity, into the basin 80′. In an embodiment, the channels 204′ can be tapered at an angle of between 0 and 90-degrees with respect to the horizontal first and second support surfaces 200a′, 200b′.

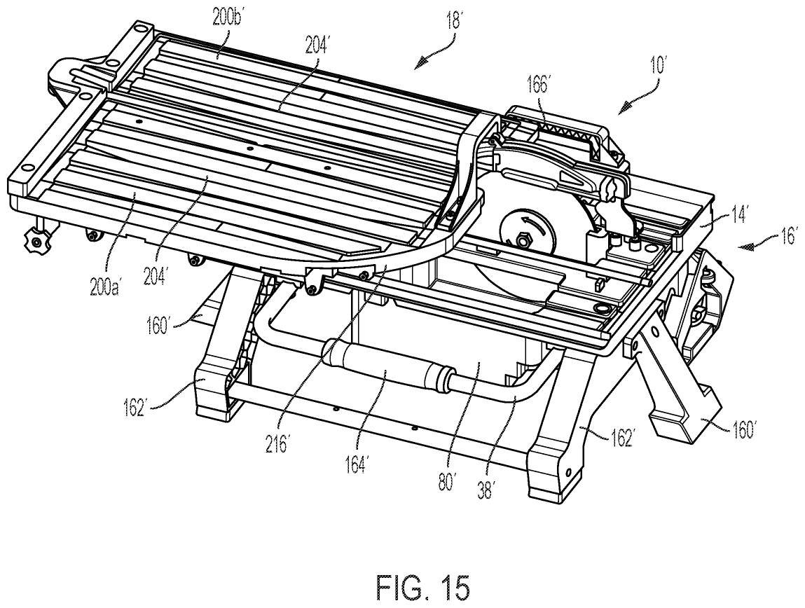

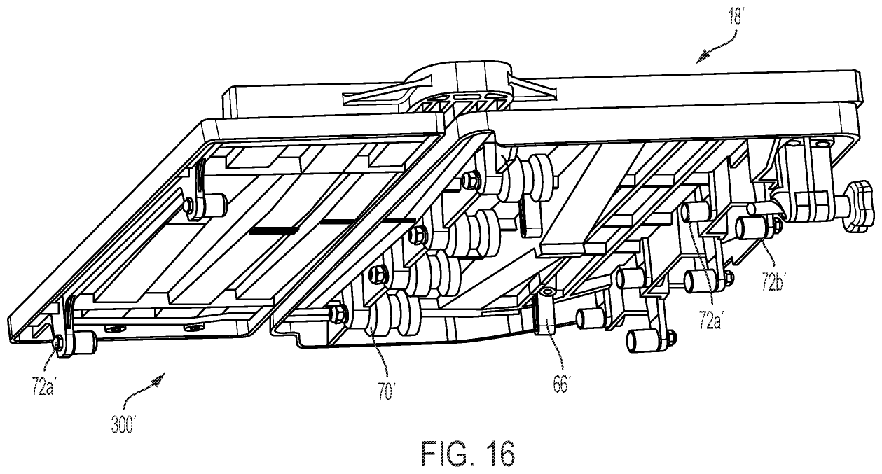

FIG. 15 illustrates the table assembly 18′ in the cantilevering position on the frame assembly 14′. In the cantilevering position, at least one set or a plurality of sets of the guide rollers and support rollers are disposed off of the rail assembly. As shown in FIG. 16, guide rollers 70′ and support rollers 72a′ and 72b′ are used to transmit the table assembly 18′ along the frame assembly 14′. The guide rollers 70′ and support rollers 72a′ and 72b′ are mounted to ribs on the underside 300′ of the table 20′ and engage the rails 30′, 32′, 34′ of the rail system 16′.

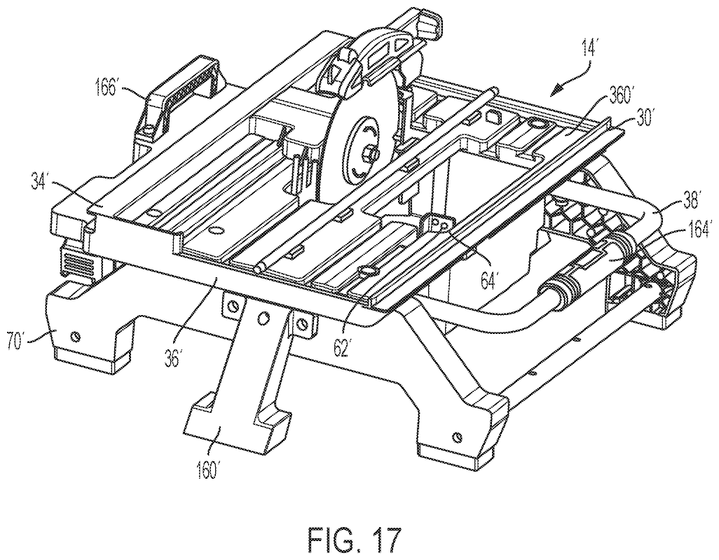

FIG. 17 illustrates a front perspective view of the tile saw 10′ with the table removed revealing a top surface 360′ of the frame assembly 14′. As shown, the front of the frame assembly 14′ has an raised edge portion integrally formed with the third rail 34′. The raised edge serves the purpose of containing water and directing it to the basin 80′. Also, as shown in FIG. 17, a first stop member 62′ is illustrated. Similar to the first embodiment, the first stop member 62′ can be a rotatable stop member that has an extension 64′ that engages one of a plurality of table catch member 66′ (FIG. 16). FIG. 17 illustrates the first stop member 62′ in a first position in which the stop member engages one of the table catch members 66′ depending from the underside of the table 20′ to limit the distance of travel of the table assembly along the longitudinal length of the tile saw and prevent the table assembly from being lifted off of the frame body 36′.

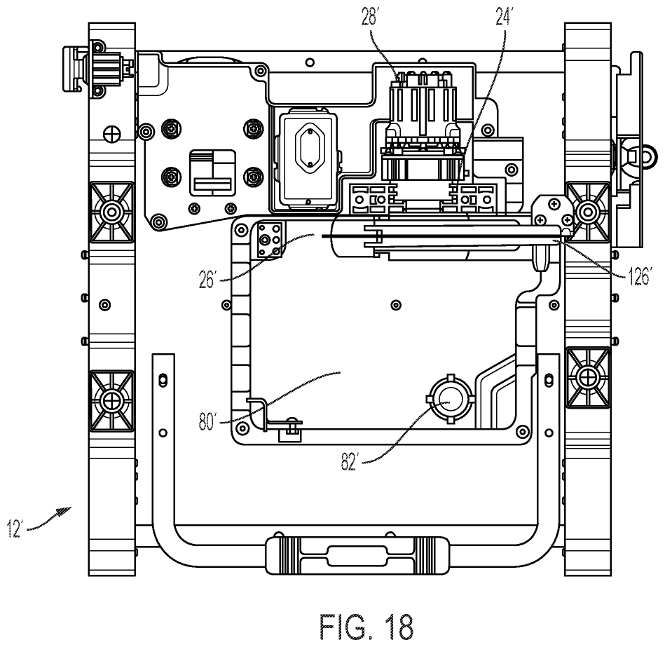

FIG. 18 illustrates a top view of the tile saw 10′ with the table assembly, frame assembly and stability legs removed. The motor 24′, transmission 28′, basin 80′ and overflow tube 82′ and blade guard 126′ are visible.

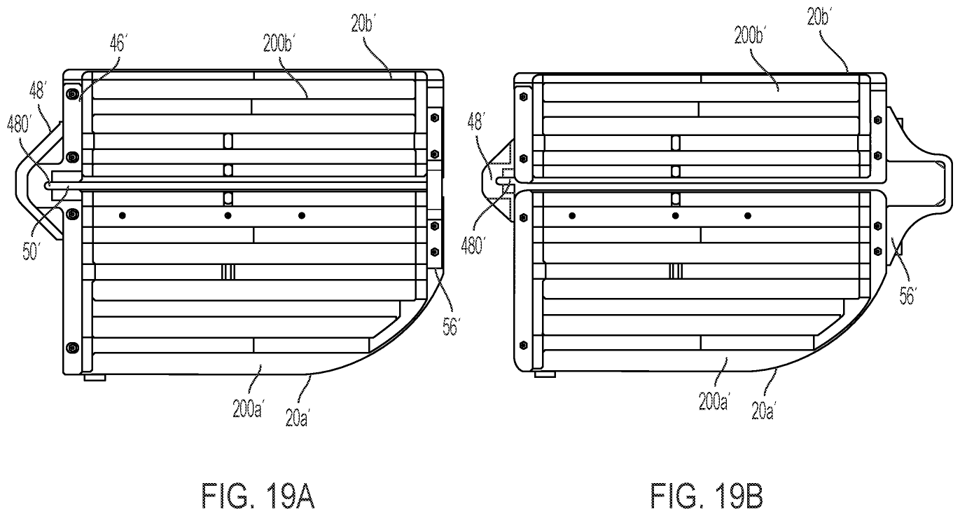

FIGS. 19A, 19B, 20A, 20B, 21A, 21B, 22 and 23 illustrate a second embodiment of the of the table in which the fences are removed and repositionable. The table 20′ has a first fence member 46′ and a second fence member 56′. The first table portion 20a′ and the second table portion 20b′ are connected by a bracket 48′ disposed below the table support surfaces 200a′ and 200b′. The bracket 48′ includes a blade channel 480′ for receiving the blade 26 when the table reaches the limit of the rail assembly 16. The bracket 48′ is provided so that if the user chooses to remove the first fence member 46′(FIG. 19B), in order to have a flat surface to cut a workpiece larger than the table 20′, the bracket 48′ remains to hold the first table portion 20a′ and the second table portion 20b′ together.

FIGS. 19A and 19B also illustrate that the first and second table portions 20a′ and 20b′ include the second fence member 56′ having a bridge portion 60′ over the table support surface 200′. The bridge portion 60′ connects the first and second table support portions at an end of the table 20′ opposite the first fence member 46′. The second fence member 56′ can be removed from a position above the table surface 200′ and repositioned on a side edge of the table 20′. The repositioning of the second fence member 56′, like the removal of the fence 46′, provides a flat surface on the table to cut a workpiece larger than the table 20′. Alternatively, the bridge portion 60′ can be releasably attached to the table surface by pins so that the bridge can be removed from the table. As the bracket 48′ would remain attached to the table 20′, the first and second table portion 20a′ and 20b′ can remain connected.

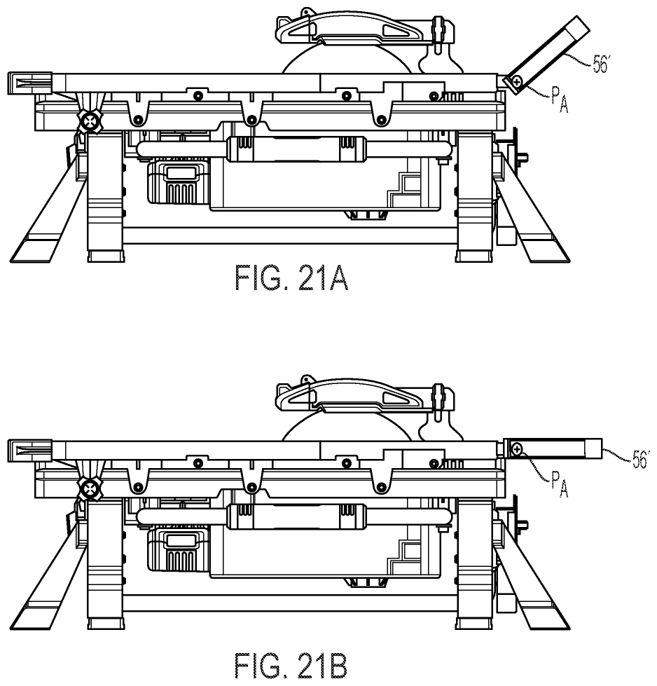

As shown in FIGS. 20A, 20B, 21B, 22A and 22B, the second fence member 56′ can be moved from an upright or vertical position above the table surface 200′ downward to a position away from the table surface 200′ to allow a workpiece larger than the table 20′ to be cut. In an embodiment, the second fence member 56′ can be moved to a horizontal position. In an embodiment, as shown in FIGS. 20A, 20B, 21A and 21B, the second fence member 56′ can be pivoted about an axis PA parallel to the axis of rotation BA of the blade 26. The second fence member 56′ can be pivoted through a hinge or a pin. In an embodiment, the second fence member 56′ can be repositioned and locked. The second fence member 56′ can also be unlocked by a retractable spring having a push-button release or other biased locking member. In FIGS. 20B, and 21B, the second fence member 56′ is rotatable about the table 20′ and can be repositioned below or parallel to the table support surface 200′. In the parallel position, the bridge portion 60′ of the fence member 56′ provides an extended surface parallel to the first and second support surfaces 200a′, 200b′ upon which the workpiece can be placed. This will allow the user to cut any length of workpiece on the table surface. The second fence member 56′ is also removable.

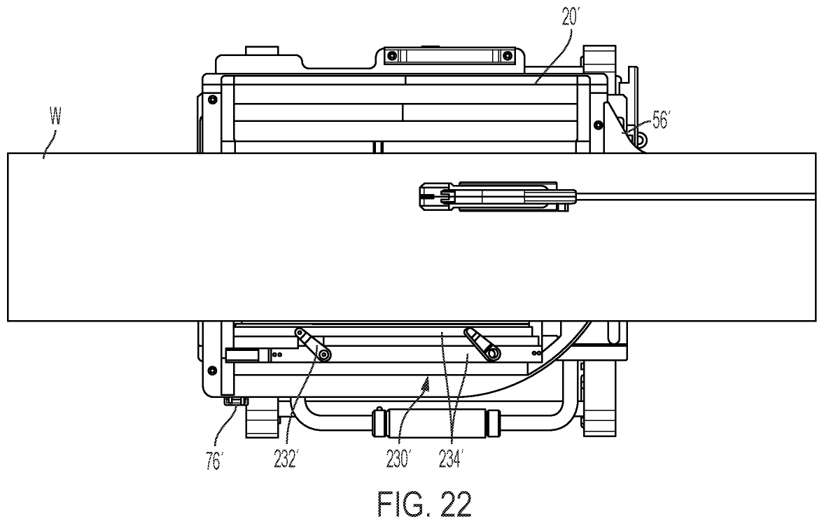

FIG. 22 illustrates an adjustable fence assembly 230′. The adjustable fence assembly 230′ is attachable to an upper surface of the table 20′. The table 20′ can have a plurality of apertures that accommodate the adjustable fence assembly 230′. A clamp 232′ and or pin can secure the adjustable fence assembly to the table 20′ A pair of parallel bars 234′ are disposable within locating holes through the support surface 200′ of the table 20′. The parallel bars 234′ move the fence toward and away from the blade 26′ for fine adjustment of the adjustable fence against the workpiece W. The adjustable fence assembly 230′ can be screwed or clamped to the table 20′. Although a pair of parallel bars are illustrated, one or more than two parallel bars can be provided.

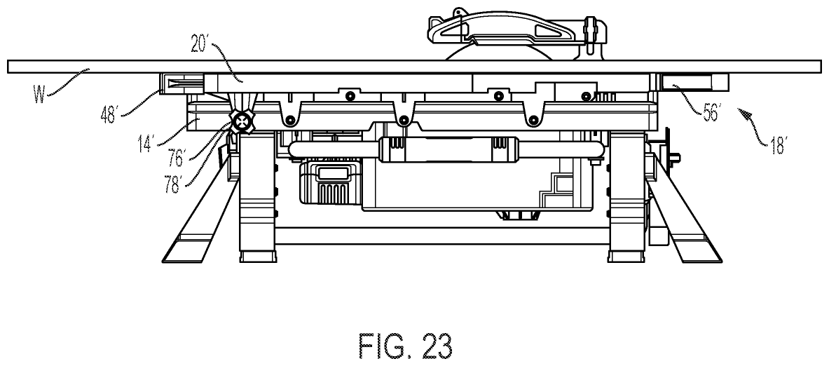

FIG. 23 illustrates the table assembly 18′ in a locked position on the frame assembly 14′. The gripping knob 76′ of the locking bar of the present embodiment is illustrated in the locked position. As shown in FIG. 23 similar to FIG. 12, the locking bar 74′ can be slidably disposed in an aperture 78′ in the frame body 36′.

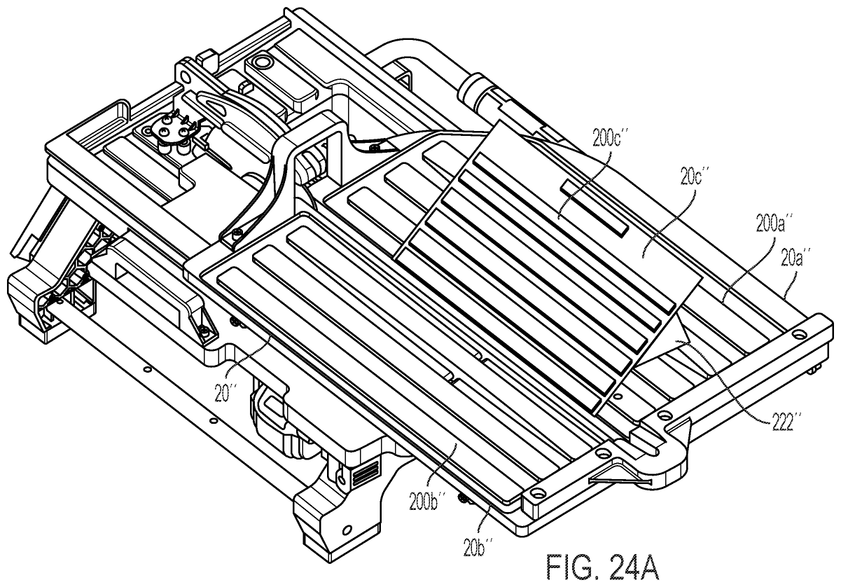

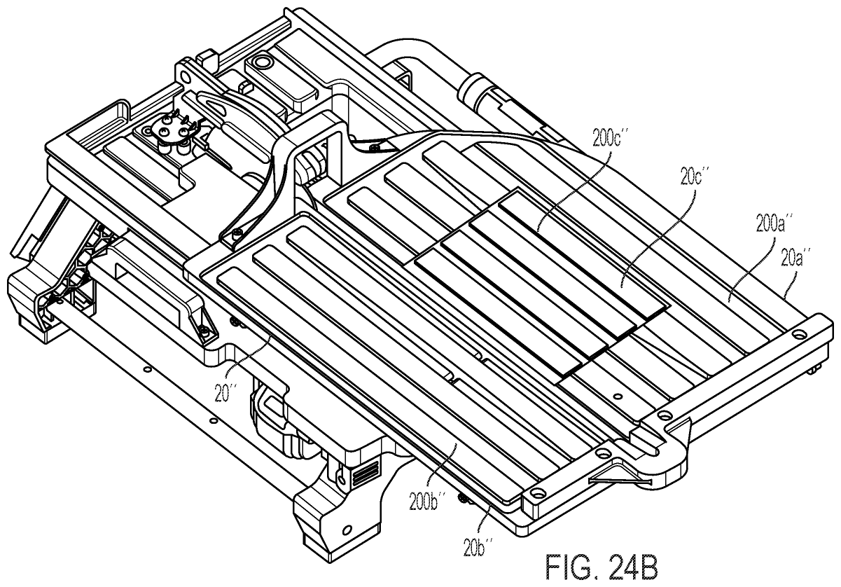

FIGS. 24A and 24B illustrate the movable table 20″ having a bevel plate 20c″. The bevel plate 20c″ allows the tile saw 10″ to make bevel cuts to the workpiece W. The bevel plate 20c″ is an adjustable section of the table 20″ that can maintain an inclined position to support a workpiece W. The bevel plate has a bevel surface 200c″. In a horizontal state, the bevel plate surface 200c″ can be flush with the first support surface 200a″ and the second support surface 200b″. In this state, as shown in FIG. 24B, the bevel plate section 20c″ is disposed in a table recess (not shown) and rests on a ledge circumscribing the inner perimeter of the recess. The ledge can be integrally cast with the table 20″. The bevel plate section 20c″ can be hinged along an axis parallel to the channels 204″ so that the bevel plate section can be pivotable to a beveling state or inclined state.

In the inclined state, as shown in FIG. 24A, the bevel plate section 20c″ is angled upward and inclined with respect to the first support surface 200a″ and the second support surface 200b″. The bevel plate section 20c″ is supported by a brace member 222″. The brace member 222″ is located in the table recess and is pivotable to an upright position to support the bevel plate section 20c″ in the inclined position. As such, the bevel plate section 20c″ is liftable from the horizontal state to the inclined state by the brace member. The brace member 222″ can support the bevel plate section 20c″ at an angle of 30-degrees, 45-degrees, and 60-degrees with respect to the first support surface 200a″ and the second support surface 200b″. In an embodiment, the brace member 222″ can support the bevel plate section 20c″ at any angle between 0 and 90-degrees. The bevel plate section 20c″ can be located on either the first table portion 20a″ or the second table portion 20b″ and be moveable therewith.

While aspects of the present invention are described herein and illustrated in the accompanying drawings in the context of a tile saw, those of ordinary skill in the art will appreciate that the invention, in its broadest aspects, has further applicability.

It will be appreciated that the above description is merely exemplary in nature and is not intended to limit the present disclosure, its application or uses. While specific examples have been described in the specification and illustrated in the drawings, it will be understood by those of ordinary skill in the art that various changes may be made and equivalents may be substituted for elements thereof without departing from the scope of the present disclosure as defined in the claims. Furthermore, the mixing and matching of features, elements and/or functions between various examples is expressly contemplated herein, even if not specifically shown or described, so that one of ordinary skill in the art would appreciate from this disclosure that features, elements and/or functions of one example may be incorporated into another example as appropriate, unless described otherwise, above. Moreover, many modifications may be made to adapt a particular situation or material to the teachings of the present disclosure without departing from the essential scope thereof. Therefore, it is intended that the present disclosure not be limited to the particular examples illustrated by the drawings and described in the specification as the best mode presently contemplated for carrying out the teachings of the present disclosure, but that the scope of the present disclosure will include any embodiments falling within the foregoing description and the appended claims.

What is claimed is:

1. A saw assembly comprising:
a base;
a frame assembly disposed on the base;
a rail system disposed on the frame assembly, the rail system extending in a longitudinal direction;
a power source;
a support assembly disposed on the frame assembly, the support assembly including a motor driven by the power source and a blade driven by the motor; and
a table assembly slidingly disposed on the rail system, the table assembly including a table body having a first table portion and an adjacent second table portion separated by a gap extending parallel to the longitudinal direction of the rail system.

2. The saw assembly according to claim 1, wherein the blade is partially disposed within the gap.

3. The saw assembly according to claim 1, further comprising at least one fence member connecting the first table portion and the second table portion.

4. The saw assembly according to claim 3, wherein the at least one fence member has a blade channel to accommodate an edge of the blade.

5. The saw assembly according to claim 3, wherein the at least one fence member comprises a first fence member connecting the first table portion and the second table portion at one end of the table body and a second fence member connecting the first table portion and the second table portion at a second end of the table body opposite the first end.

6. The saw assembly according to claim 1, wherein the power source comprises a battery.

7. A saw assembly comprising:
a base;
a frame assembly disposed on the base;
a rail system disposed on the frame assembly, the rail system extending in a longitudinal direction;
a support assembly disposed on at least one of the base and the frame assembly and including a motor, and a blade driven by the motor; and
a table assembly slidingly disposed on the rail system, the table assembly having a table body, the table body including a gap therethrough, parallel to the longitudinal direction of the rail system.

8. The saw assembly according to claim 7, further comprising a power source to supply power to the motor.

9. The saw assembly according to claim 8, wherein the power source comprises a motor.

10. The saw assembly according to claim 7, wherein the rail assembly comprises a plurality of parallelly arranged rails having different cross-sections.

11. The saw assembly according to claim 7, wherein the rail assembly comprises at least one rail that is integrally formed with the frame assembly.

12. A saw assembly comprising:
a base;
a frame assembly disposed on the base;
a rail system disposed on the frame assembly, the rail system extending in a longitudinal direction;
a support assembly disposed on at least one of the base and the frame assembly and comprising a motor, and a blade driven by the motor;
a table assembly slidingly disposed on the rail system, the table assembly having a table body, the table body including a gap therethrough, parallel to the longitudinal direction of the rail system;
at least one fence member disposed at a longitudinal end of the table assembly, the at least one fence member having a portion pivotably attached thereto.

13. The saw assembly according to claim 12, wherein the table body includes a recess in an upper surface thereof and a bevel plate is supported in the recess.

14. The saw assembly according to claim 13, wherein the bevel plate is pivotable to a plurality of angles with respect to the upper surface of the table body.
